(19) United States
(12) Patent Application Publication
(10) Pub. No.: US 2007/0116925 A1
(43) Pub. Date: May 24, 2007

(54) Motor vehicle undercarriage paneling as well as method for manufacturing the same

(75) Inventors: Stefan Schatz, Gottingen (DE); Hans-Jurgen Stellmach, Schladen (DE)

Correspondence Address: DENNISON, SCHULTZ & MACDONALD, 1727 KING STREET, SUITE 105, ALEXANDRIA, VA, 22314, US

(73) Assignee: ICOS GmbH

(21) Appl. No.: 11/281,889

(22) Filed: Nov. 18, 2005

(51) Int. Cl. B32B 3/10; B32B 1/00

(52) U.S. Cl. 428/131; 428/174

(57) ABSTRACT

The invention relates to an undercarriage paneling (10) manufactured by means of injection molding from glass fiber-free polypropylene. To obtain the desired material properties, at least one additive is added, which improves at least the heat stability.

The invention relates to a motor vehicle undercarriage paneling with basically areal extension comprising structured regions for increasing strength and/or fastening on the motor vehicle, whereby polypropylene is the basic material of the undercarriage paneling, to which an additive influencing at least density, bending-elasticity module and or impact strength of the undercarriage paneling is added. The invention also relates to a method for the manufacture of an aerodynamically designed motor vehicle undercarriage paneling of basically areal extension comprising structured regions to increase strength and/or for fastening on the motor vehicle using polypropylene as a basic material.

Automobile body parts made of plastic are being used increasingly in the automotive field. For example manufacturing body parts of polyamide is known. Oil pans may be mentioned as examples. Bellows for shock absorbers can be made of polychloroprene rubber for commercial vehicles in particular. Panelings in the motor vehicle undercarriage can be made of polypropylene, whereby long glass fibers must also be contained for reasons of impact strength and the desired elasticity module, but also due to the high temperatures arising in the exhaust region. The corresponding motor vehicle undercarriage panelings are manufactured by means of pressing or injection molding. Corresponding motor vehicle undercarriage panelings have a great stiffness. But it is disadvantageous that a health risk develops due to glass fiber particles resulting from the glass fibers present during finishing of the manufactured parts. Corresponding panelings also cannot be recycled to the desired extent due to the glass fiber component. If undercarriage panelings are manufactured by means of pressing, additional stamping operations must be conducted to form slots or other perforations, whereby the disadvantage arises that incipient cracks occur, owing to which the lifetime is impaired. Moreover stamping involves considerable costs, not solely due to the additional stamping operation, but due to the tools themselves, since their contour must correspond to that of the region in which the perforation is to be stamped out in order to rule out deformations of the pressed part.

In injection molding, there is the disadvantage that tools having expensive spring mechanisms are required.

The processing of glass fibers, be it through admixture into the basic material propylene or by applying glass fiber mats with pressure, is considered necessary not only due to the desired material properties, but also on account of the requisite stiffness of the floor paneling.

A polymer mixture for manufacturing automobile parts such as fenders to improve the ability to paint them is known from European Patent 1,362,886.

German Patent 198 17 567 relates to a wheel cover, which consists of a first surface area consisting of thermoplastic material and a second surface area consisting of textile plastic, which are joined with each other. The plastic material may contain a recycled material.

The present invention is based upon the objective of further developing a motor vehicle undercarriage paneling as well as a method for manufacturing the same such that the advantages in relation to the material properties of known undercarriage panelings are retained, but their disadvantages are avoided. In this connection finishing by stamping as well as health risks are especially to be avoided. Furthermore a high degree of accuracy should be attainable. The tool necessary for manufacturing the undercarriage paneling should have a simple design.

An improvement in noise damping should also be attainable. Resistance to breakage from rocks should also be increased. An economical basic material should be used for manufacturing the motor vehicle undercarriage paneling, whereby it should also be recyclable.

To accomplish the objective, a motor vehicle undercarriage paneling of the type mentioned at the beginning is proposed in accordance with the invention which is distinguished in that the motor vehicle undercarriage paneling is an injection molded part, in that the basic material is a ground recycled glass fiber-free polypropylene to which at least one elastomer as well as at least one mineral additive is admixed, and in that the motor vehicle undercarriage paneling has a bending elasticity module E of 1,000 MPa≦E≦1,280 MPa, a density ρ of 1.00 g/cm³≦ρ≦1.16 g/cm³ and/or an impact strength K at 23⁰ C of 25 KJ/m²≦K≦KJ/m².

Deviating from previously known undercarriage panelings, and in contrast to the demands made by expert circules, a glass fiber-free polypropylene is used as the basic material, is the polypropylene being moreover recycled. Consequently an economical basic material is used that is molded, so that in comparison with the use of injection molding, economical tools can be used. At the same time it is assured that the undercarriage paneling has desired material thicknesses within narrow tolerances, an advantage which does not develop when pressing the undercarriage panelings. Furthermore, at least one additive, such as talc or limestone, is introduced to adjust the material properties especially in relation to bending and elasticity modules, density and impact strength, resulting in the same or even better properties as those of previous glass fiber-containing undercarriage panelings. Moreover, it is not disadvantageous that the molded undercarriage paneling is quite flexible, thus has a low internal rigidity, since the desired dimensional stability is assured by fastening on the motor vehicle. However, there is the advantage that impacting stones are dampened resulting in reduced noise on the basis of the flexibility, that is the mobility of the undercarriage paneling.

In this connection, the undercarriage panelings have a specified aerodynamics, i.e. such a Cw value that undesirable turbulence is avoided.

Using recycled polypropylene in the automotive area is indeed known. The designated polypropylene nonetheless replaces exclusively those motor vehicle parts, which are otherwise made of the original material polypropylene, which is nonetheless relatively expensive due to its manufacture.

It is in particular provided that the polypropylene basic material is made of ground accumulator box material or contains it.

In order to attain the desired flexibility, it is provided that the elastomer, such as in particular EPDM (ethylene-propylene-diene monomer) consists of production waste and/or recycled motor vehicle material, or contains it. Consequently, an economical additive can be admixed economically to available recycled glass fiber-free polypropylene to attain the desired material properties. In particular, a limestone and/or talc additive is provided, the proportion of which by weight should be smaller than 3%. The impact strength and the bending elasticity module are in particular positively influenced by the corresponding additive. Good deformability properties also results from the injection molding tool.

When using talc, it should have a mean diameter d of 0.5 μm≦d≦15 μm, especially 0.5 μm≦d≦5 μm.

The yield stress Sp of 12 MPa≦Sp≦15 MPa and/or extension strain Sd of 3%≦Sd≦5% and/or fracture stress Bs of 9 Mpa≦Bs≦13 Mpa and/or elongation at fracture Bd of 50%≦Bd≦60% are additional characteristic data for the inventive motor vehicle undercarriage paneling that should be mentioned. Furthermore the motor vehicle undercarriage paneling should have a Shore hardness D between 60 and 65.

The yield stress, extension stress, fracture stress are tested according to EN ISO 527-2. The testing methods for density are based upon DIN 53 479, on EN ISO 178 for the bending elasticity module, on DIN 53 505 (3 s) for Shore D hardness and on ISO 179/1eA for impact strength.

Furthermore provided is a structuring comprising hollow ribs, which have apertures in low points, if need be to increase the rigidity of the motor vehicle undercarriage paneling. In this way, it is assured that if need be accumulated condensate can flow off.

Independently of this, the undercarriage paneling has perforations such as apertures or slots to the desired extent, which can be formed during molding so that no finishing is needed.

An undercarriage paneling is furnished in accordance with the invention, which corresponds in terms of material thickness and shape to glass fiber-reinforced polypropylene. Consequently design changes in respect to the motor vehicle itself are not necessary in order to fasten the undercarriage panelings of the invention.

A method for manufacturing an aerodynamically designed motor undercarriage paneling of basically areal extension with structured regions to increase strength and/or for fastening on the motor vehicle when using polypropylene as a basic material is distinguished by the following steps:
Mixing ground, recycled glass fiber-free polypropylene-containing material with at least one heat stability-increasing additive,
Compounding the mixture produced this way, and
Injection molding the compounded material, whereby a tool having a cavity specifying the shape of the motor vehicle undercarriage paneling is used, the inner surface of which is adjusted independently of the contour to the same or basically the same temperature during injection molding.

In accordance with the invention, a motor vehicle undercarriage paneling is manufactured by injection molding from recycled glass fiber-free polypropylene, whereby an additive is introduced that leads to an increase in heat stability. This enables problem-free usage in the undercarriage region even in the area of heat-conducting parts, thus in particular also in the exhaust region.

To assure sufficient dimensional accuracy, it is furthermore provided in accordance with the invention that the cavity of the tool is set on the inner surface side to the same or almost the same temperature so that the desired flow of the plastified polypropylene material containing the at least one additive is assured, and as a consequence specified material thicknesses can also be maintained. Here it is especially provided that the tool is subdivided into sectors, which are tempered independently of one another to assure the desired temperature profile.

Furthermore, the invention is distinguished by the use of recycled polypropylene material comprising at least one additive influencing the material properties for manufacturing an aerodynamically designed glass fiber-free motor vehicle undercarriage paneling by means of injection molding. Moreover recycled material is used as the polypropylene material, especially ground accumulator housing material. Shredded fender material of polypropylene can also be used, whereby the advantage exists that EPDM is already contained.

Talc and/or limestone can be used as an additive. In addition, mica or another heat stabilizer can be used as an additive to improve heat stability.

Further details, advantages and features of the invention result not only from the claims, the features to be inferred from them-alone and/or in combination—but also from the following description of a preferred embodiment to be inferred from the drawings, wherein:

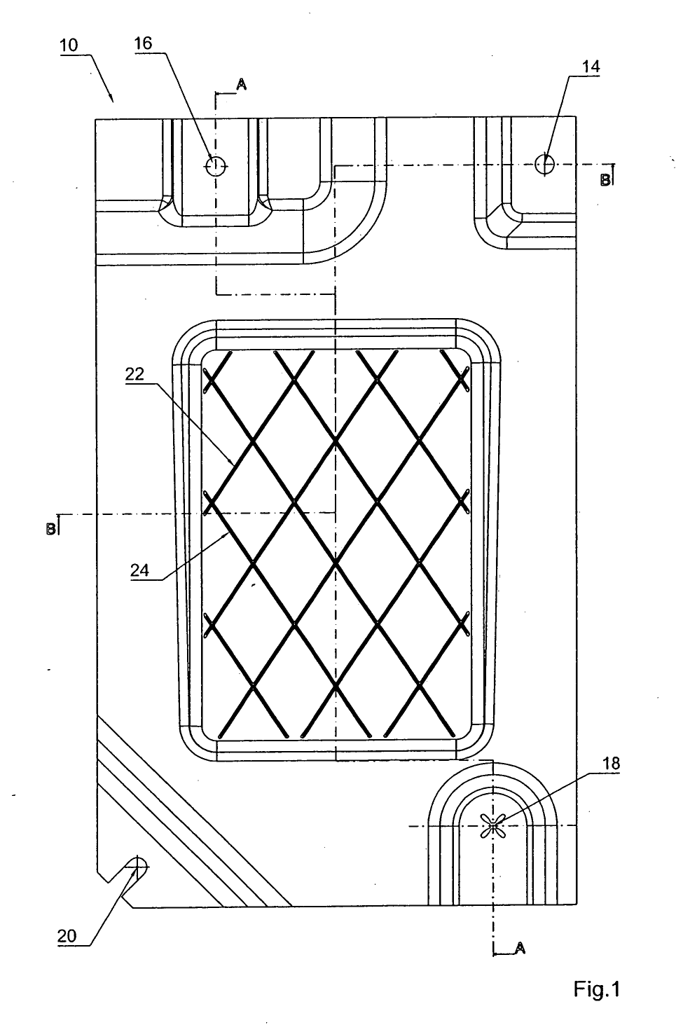

FIG. 1 Is a plan view on a motor vehicle undercarriage paneling,

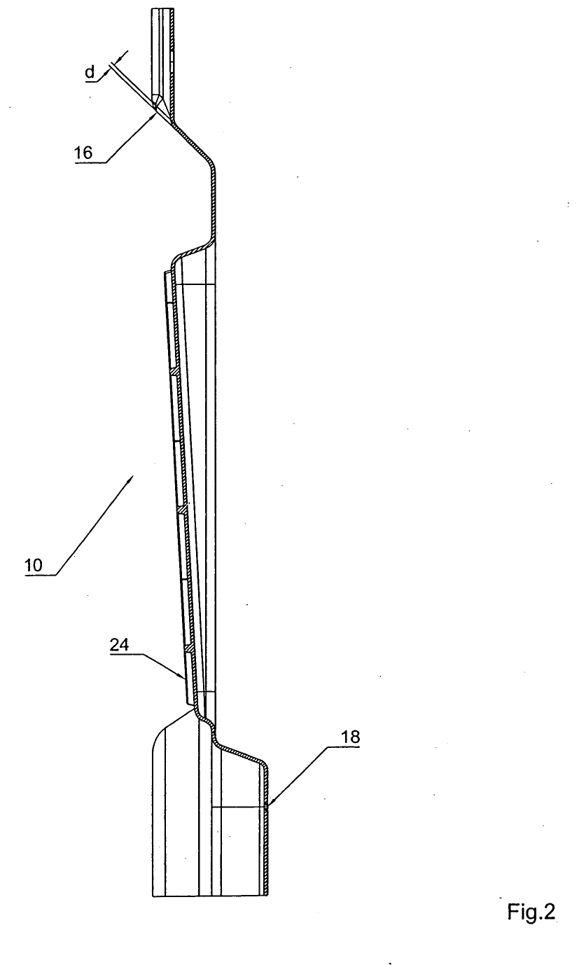

FIG. 2 Is a section along line A-A in FIG. 1,

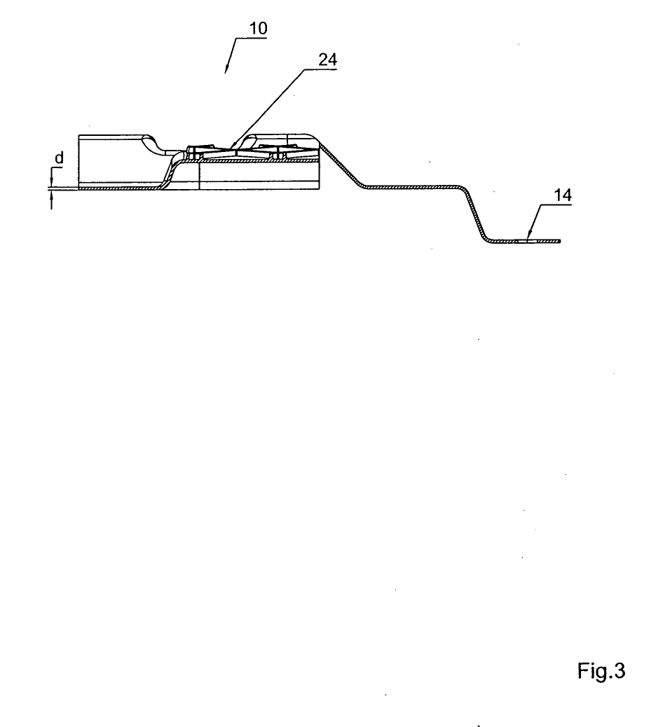

FIG. 3 Is a section along line B-B in FIG. 1,

FIG. 4 Is an outline representation of an undercarriage of a motor vehicle,

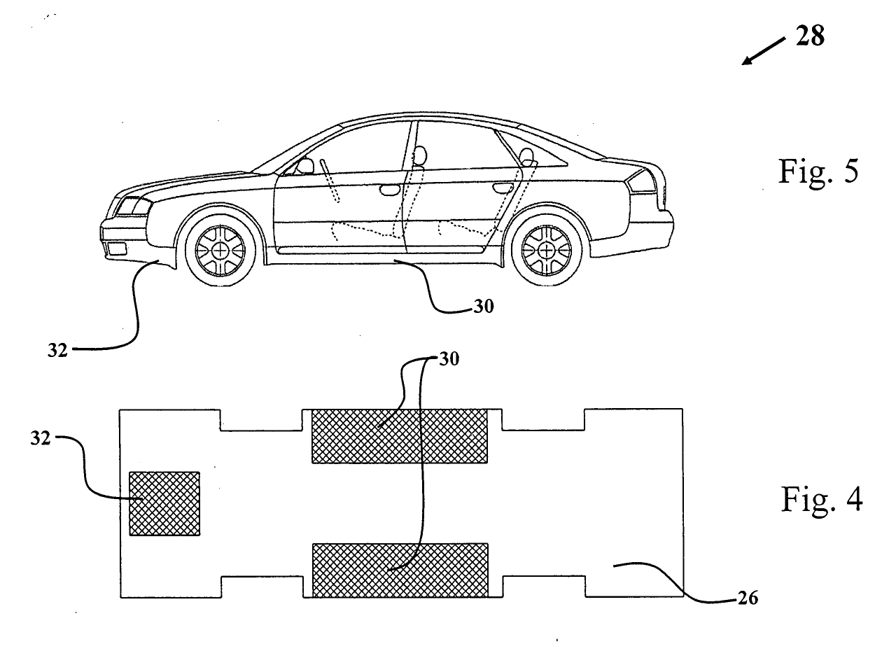

FIG. 5 Is an outline representation of a motor vehicle,

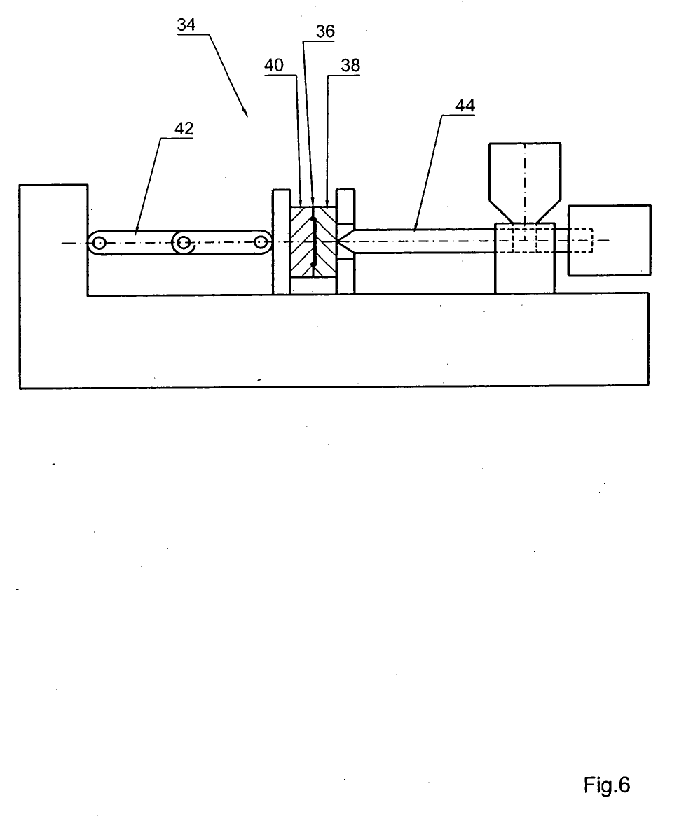

FIG. 6 Is an injection molding machine in the closed state and

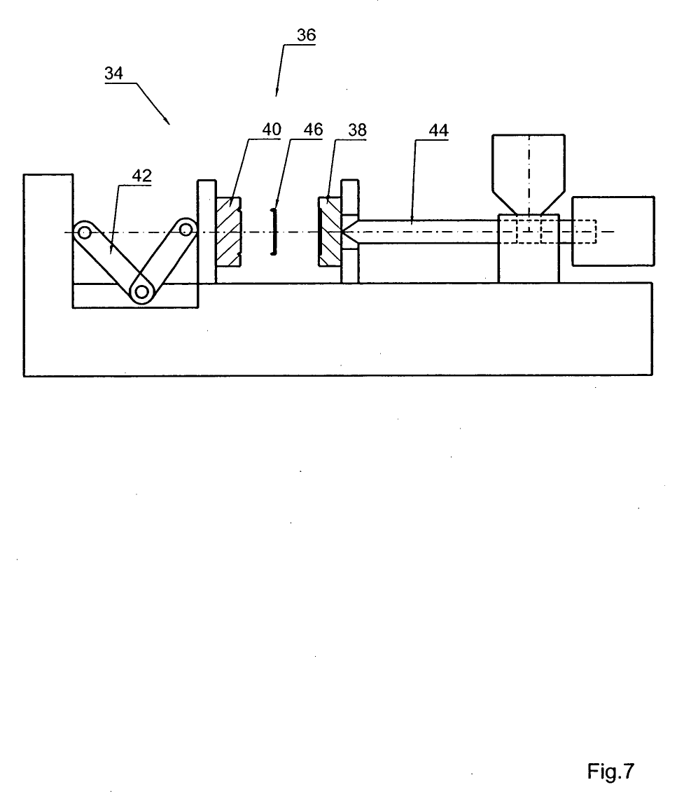

FIG. 7 Is the injection molding machine according to FIG. 6 in the open state.

A motor vehicle undercarriage paneling 10 is represented purely schematically in FIGS. 1-3, which is basically an areal element. The undercarriage paneling 10 has a rectangular shape in top view, whereby perforations 14, 16, 18 or slots 20 are present in corner or outer edge regions to fasten the undercarriage paneling 10 to the floor of a motor vehicle. Furthermore, bar-like ribs 22, 24 are provided in the middle region to attain a desired rigidity. Otherwise the shape of the undercarriage paneling 10 is adapted to that of the undercarriage of the motor vehicle to be covered or the components of the motor vehicle running along the undercarriage, such as the exhaust.

The corresponding undercarriage paneling 10 represented purely in outline in the Figures has, for example, a thickness d of 2 mm, the areal extension can amount to 1400×800 mm². The undercarriage paneling 10 is manufactured by means of injection molding, whereby ground, recycled glass fiber-free polypropylene is used as the basic material. This can be recycled accumulator box material or fender material. Talc at 2.8% by weight and mica at 1% by weight are added to the basic material. As a result, the material properties of the undercarriage paneling 10 are improved in comparison to such consisting of glass fiber-reinforced polypropylene or pressure applied glass-fiber mats.

The bars or reinforcement ribs 22, 24 extend in particular on the inside so that the latter cannot lead to turbulence. Consequently, the reinforcements do not worsen the Cw value of a corresponding undercarriage paneling in comparison to known values.

An outline representation of a view from beneath of a motor vehicle floor 26 of a motor vehicle 28 is represented in FIG. 4. The areas cross hatched in the longitudinal regions are supposed to symbolize floor panelings 30, which basically do not run in the visible region of the motor vehicle 28, thus auto body parts which to not cover doors.

With the motor vehicle undercarriage paneling manufactured according to the theory of the invention, a floor side motor paneling or motor damping diffuser 32 however is also possible, which is symbolized by the tinted region in the front region of the motor vehicle 28. The corresponding undercarriage panelings 30, 32 have a low CW value. At the same time they offer the desired flexibility with noise damping. Desired shapes can be attained through the manufacture by means of injection molding without it requiring finishing.

An injection molding machine 34 with a tool 36 can be gathered purely in outline from FIGS. 6 and 7, the tool consisting of a nozzle element 38 and a closing element 40 in the usual manner. The closing element 40 is staggered in the direction of the nozzle element 38 in the molding position (FIG. 6), in the embodiment specifically by means of a lever 42. Then the plastified recycled glass fiber-free polypropylene with the elastomer and at least one mineral supplement as an additive is sprayed into the molding cavity through an extruder 44. The tool 36 is subsequently opened and the molded part is removed in the form of a motor vehicle undercarriage paneling 46.

In order to obtain an optimal distribution of the plastified plastic in the cavity, independently of the various dimensions of the molded part to be manufactured, segments of the nozzle element 38 or closing element 40 can be tempered differently.

1. Motor vehicle undercarriage paneling (10, 30, 32, 46) of basically areal extension comprising structured regions to increase strength and/or for fastening on the motor vehicle (28), whereby propylene is the basic material of the undercarriage paneling, to which at least one additive influencing the density, bending elasticity module and/or impact strength of the undercarriage paneling is introduced, wherein the motor vehicle undercarriage paneling (10, 30, 32, 46) is an injection molded part, wherein the basic material is ground, recycled glass fiber-free polypropylene to which at least an elastomer as well as at least one mineral supplement is admixed as an additive, and wherein the motor vehicle undercarriage paneling has a bending elasticity module E of 1,000 MPa≦E ≦1,280 MPa, a density ρ of 1.00 g/cm³≦ρ≦1.16 g/cm³ and/or an impact strength K at 23⁰C. of 25 KJ/m²≦K≦44 KJ/m²

2. Motor vehicle undercarriage paneling according to claim 1, wherein the polypropylene material is manufactured from ground accumulator box material or contains it.

3. Motor vehicle undercarriage paneling according to claim 1, wherein the polypropylene material is made of shredded motor vehicle fender material or contains it.

4. Motor vehicle undercarriage paneling according to claim 1, wherein the elastomer, such as especially EPDM, consists of production waste and/or recycled motor vehicle material or is it.

5. Motor vehicle undercarriage paneling according to claim 1, wherein limestone and/or talc is contained as an additive.

6. Motor vehicle undercarriage paneling according to claim 1, wherein the proportion of limestone and/or talc is ≦3% by weight.

7. Motor vehicle undercarriage paneling according to claim 5 or 6, wherein finely ground talc with a mean particle diameter d of 0.5 μm≦d≦15 μm, especially 0.5 μm≦d≦5 is admixed as an additive.

8. Motor vehicle undercarriage paneling according to claim 1, wherein the undercarriage paneling (10, 30, 32, 46) is characterized by a yield strain Sp of 12 MPa≦Sp≦15 MPa and/or an extension strain Sd of 3%≦Sd≦5% and/or a fracture stress BS of 9 MPa≦Bs≦13 MPa and/or a nominal fracture strain Bd of 50%≦Bd≦60%.

9. Motor vehicle undercarriage paneling according to claim 1, wherein the motor vehicle undercarriage paneling (10, 30 ,32, 46) has a Shore D hardness between 60 and 65.

10. Motor vehicle undercarriage paneling according to claim 1, wherein the motor vehicle undercarriage paneling (10, 30, 32, 46) has an impact strength K₁ at −30⁰C of 3 KJ/m²≦K₁≦8 KJ/m².

11. Motor vehicle undercarriage paneling according to claim 1, wherein the motor vehicle undercarriage paneling (10, 30, 32, 46) is structured by hollow ribs (22, 24) which have apertures in low points.

12. Motor vehicle undercarriage paneling according to claim 1, wherein the motor vehicle undercarriage paneling (10, 30, 32, 46) has perforations (14, 16, 18, 20) such as apertures or slots, which are formed during injection molding.

13. Method for manufacturing an aerodynamically designed motor vehicle undercarriage paneling (10, 20, 32, 46) according to at least claim 1, whereby the motor vehicle undercarriage paneling is of basically areal extension with structured regions (22, 24) to increase strength and/or for fastening on the motor vehicle (28) when using propylene as a basic material, characterized by the following steps:
Mixing ground, recycled glass fiber-free polypropylene-containing material with at least one heat stability-increasing additive,
Compounding the mixture produced this way, and
Injection molding the compounded material, whereby a tool having a cavity specifying the shape of the motor vehicle undercarriage paneling (10, 20, 32, 46) is used, the inner surface of which is adjusted independently of the contour to the same or basically the same temperature during injection molding.

14. Method according to claim 13, wherein the tool is subdivided into sectors, which are tempered independently of one another.

15. Use of recycled polypropylene material with at least one additive influencing material properties for manufacturing a component manufactured by means of injection molding arranged in the floor region of a motor vehicle (28), wherein the component is an aerodynamically designed motor vehicle undercarriage paneling (10, 30, 32, 46) according to at least claim 1.

16. Use according to claim 14, whereby ground accumulator housing material is the polypropylene material.

17. Use according to claim 15, whereby talc and/or limestone is the additive.

18. Use according to claim 15 or 16, whereby mica is used as an additive or supplemental additive.

19. Use according to claim 15, whereby shredded motor vehicle fender material is the polypropylene material.
